(19) United States
(12) Patent Application Publication
(10) Pub. No.: US 2026/0178047 A1
(43) Pub. Date: Jun. 25, 2026

(54) METHOD AND DEVICE WITH ROBOT CONTROL

(71) Applicant: Samsung Electronics Co., Ltd., Suwon-si (KR)

(72) Inventors: Junyoung BYUN, Suwon-si (KR); Jaewook YOO, Suwon-si (KR); Hyunwoong CHO, Suwon-si (KR)

(73) Assignee: Samsung Electronics Co., Ltd., Suwon-si (KR)

(21) Appl. No.: 19/233,298

(22) Filed: Jun. 10, 2025

(30) Foreign Application Priority Data
Dec. 23, 2024 (KR) 10-2024-0194199

(51) Int. Cl. G05D 1/648; G05D 1/2285; G05D 1/69; G05D 107/40; G05D 109/10

(52) U.S. Cl. CPC G05D 1/648; G05D 1/2285; G05D 1/69; G05D 2107/40; G05D 2109/10

(57) ABSTRACT

A processor-implemented method includes updating a dynamic scene graph by adding, to the dynamic scene graph, object-level history information corresponding to a target object, of which a state changes according to an interaction with a robot that occurs through an execution of an instruction for a task of a target robot, and controlling the target robot based on the updated dynamic scene graph, in response to receiving a target instruction corresponding to the target object.

### CROSS-REFERENCE TO RELATED APPLICATIONS

This application claims the benefit under 35 USC § 119(a) of Korean Patent Application No. 10-2024-0194199, filed on Dec. 23, 2024 in the Korean Intellectual Property Office, the entire disclosure of which is incorporated herein by reference for all purposes.

### BACKGROUND

### 1. Field

The following description relates to a method and device with robot control.

### 2. Description of Related Art

Robots may provide convenience in various fields of daily life, performing repetitive tasks such as assembly, welding, and painting in manufacturing, assisting with surgery, patient monitoring, and rehabilitation treatment, and supporting various tasks at home such as cleaning, cooking, and security. Robots may help users with daily lives through interaction, for example, by voice recognition or instruction transfer.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes updating a dynamic scene graph by adding, to the dynamic scene graph, object-level history information corresponding to a target object, of which a state changes according to an interaction with a robot that occurs through an execution of an instruction for a task of a target robot, and controlling the target robot based on the updated dynamic scene graph, in response to receiving a target instruction corresponding to the target object.

The history information may include any one or any combination of any two or more of a previous state of the target object, comprising any one or any combination of any two or more of a previous position coordinate of the target object, a previous direction of the target object, and a positional relationship with one or more other objects located in a same space as the target object, a first instruction previously performed in response to the target object, time information corresponding to the first instruction, and a previous user that issued the first instruction.

The updating of the dynamic scene graph may include updating the dynamic scene graph by adding, to an object node, history information of one or more other objects, of which a state changes together with the target object due to the interaction, in a form of an attribute, wherein the object node corresponds to the target object.

The history information of the one or more other objects may include any one or any combination of any two or more of a previous state of the one or more other objects, comprising any one or any combination of any two or more of a previous position coordinate of the one or more other objects, a previous direction of the one or more other objects, and a positional relationship between the one or more other objects and the target object, a second instruction previously performed in response to the one or more other objects, time information corresponding to the second instruction, and a previous user that issued the second instruction.

The updating of the dynamic scene graph may include storing the history information in a plurality of slots of an object node corresponding to the target object in the dynamic scene graph in a form of a stack data structure.

The updating of the dynamic scene graph may include, in response to another robot being located in a space in which the target robot executes the target instruction, updating the dynamic scene graph by adding information on the target robot that executed the target instruction to the history information corresponding to the target object, and the method may include sharing the updated dynamic scene graph with the other robot.

The method may include recognizing a voice of a user corresponding to the target instruction, wherein the updating of the dynamic scene graph may include updating the dynamic scene graph by adding information on the user whose voice has been recognized to the history information corresponding to the object node in the dynamic scene graph.

The controlling of the target robot may include controlling the target robot to execute the target instruction for the user whose voice has been recognized.

The controlling of the target robot may include supplementing a missing information item that is missing from the target instruction, based on the updated dynamic scene graph, and controlling the target robot according to the target instruction with the information item supplemented.

The target instruction may include either one or both of an instruction in a form of text and an instruction in a form of voice, for a task of the target robot.

In one or more general aspects, a device includes one or more processors configured to update a dynamic scene graph by adding, to the dynamic scene graph, object-level history information corresponding to a target object, of which a state changes according to an interaction with a robot that occurs through an execution of an instruction for a task of a target robot, and control the target robot based on the updated dynamic scene graph, in response to receiving a target instruction corresponding to the target object.

The history information may include any one or any combination of any two or more of a previous state of the target object, comprising any one or any combination of any two or more of a previous position coordinate of the target object, a previous direction of the target object, or a positional relationship with one or more other objects located in a same space as the target object, a first instruction previously performed in response to the target object, time information corresponding to the first instruction, and a previous user that issued the first instruction.

The one or more processors may be configured to update the dynamic scene graph by adding, to an object node, history information of one or more other objects, of which a state changes together with the target object due to the interaction, in a form of an attribute, wherein the object node corresponds to the target object.

The history information of the one or more other objects may include any one or any combination of any two or more of a previous state of the one or more other objects, comprising at least one of a previous position coordinate of the one or more other objects, a previous direction of the one or more other objects, or a positional relationship between the one or more other objects and the target object, a second instruction previously performed in response to the one or more other objects, time information corresponding to the second instruction, and a previous user that issued the second instruction.

The one or more processors may be configured to store the history information in a plurality of slots of an object node corresponding to the target object in the dynamic scene graph in a form of a stack data structure.

The one or more processors may be configured to in response to another robot being located in a space in which the target robot executes the target instruction, update the dynamic scene graph by adding information on the target robot that executed the target instruction to the history information corresponding to the target object, and share the updated dynamic scene graph with the other robot.

The one or more processors may be configured to recognize a voice of a user corresponding to the target instruction, and update the dynamic scene graph by adding information on the user whose voice has been recognized to the history information corresponding to the object node in the dynamic scene graph.

The one or more processors may be configured to control the target robot to execute the target instruction for the user whose voice has been recognized.

The one or more processors may be configured to supplement a missing information item that is missing from the target instruction, based on the updated dynamic scene graph, and control the target robot according to the target instruction with the information item supplemented.

The device may include a communication circuit configured to receive either one or both of an instruction in a form of text and an instruction in a form of voice, for the task of the target robot.

Other features and aspects will be apparent from the following detailed description, the drawings, and the claims.

### BRIEF DESCRIPTION OF THE DRAWINGS

FIG. 1 illustrates an example of a typical scene graph.

FIG. 2 illustrates an example of a method of controlling a robot by using a dynamic scene graph.

FIG. 3 illustrates a flowchart of an example of a robot control method.

FIGS. 4A to 4C illustrate an example of a method of controlling a robot by using a dynamic scene graph with augmented object-level history information.

FIGS. 5A to 5F illustrate an example of a process in which a dynamic scene graph changes during an execution of a target instruction.

FIG. 6 illustrates an example of an operation of a robot when a dynamic scene graph stores a most recent history.

FIG. 7 illustrates an example of managing object-level history information in a form of a stack data structure.

FIGS. 8A and 8B illustrate an example of a method in which a target robot remembers a relationship with one or more other objects through a dynamic scene graph when operating.

FIG. 9 illustrates an example of a method in which a target robot processes an instruction of a user while coexisting in a same space as another robot.

FIGS. 10A and 10B illustrate an example of an operation when a target instruction causes various state changes other than a positional change of a target object.

FIGS. 11A to 11C illustrate an example of a method of controlling a robot for each user by recognizing a speaker of a target instruction.

FIG. 12 illustrates an example of a robot control device.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms used herein including technical and scientific terms have the same meanings as those commonly understood by one of ordinary skill in the art to which this disclosure pertains and after an understanding of the present disclosure. Terms such as those defined in commonly used dictionaries are to be interpreted as having a meaning that is consistent with their meaning in the context of the relevant art and the present disclosure, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The embodiments described below may be applied to, for example, a walking assist device (WAD), a drone, and/or a robot.

Hereinafter, the examples are described in detail with reference to the accompanying drawings. When describing the examples with reference to the accompanying drawings, like reference numerals refer to like components and a repeated description related thereto is omitted.

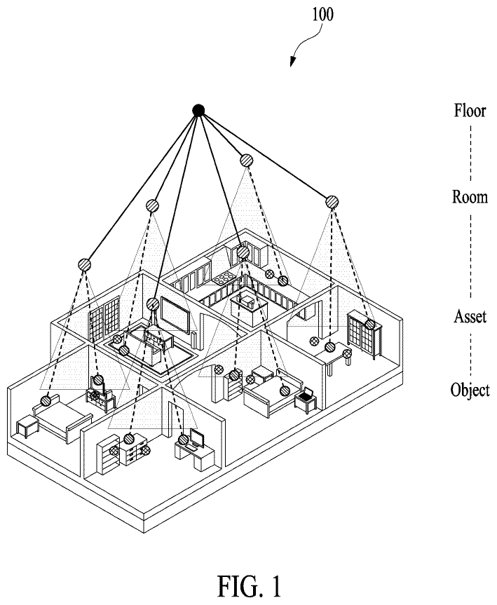

FIG. 1 illustrates an example of a typical scene graph. Referring to FIG. 1, an example of a three-dimensional (3D) scene graph 100 is shown.

The scene graph 100 may be a graph that describes objects in an arbitrary space and relationships between the objects. The scene graph 100 may express a scene by dividing the scene into multiple levels (or layers), such as buildings, rooms, and objects. The scene graph 100 shown in FIG. 1 may have a hierarchical structure in a form of a tree or a graph in which each room included in a floor, an asset included in each room, and/or an object belonging to each asset are included. Each node of the scene graph 100 may represent a floor, a room, an asset, or an object in the corresponding scene. The nodes may be connected to each other in a tree structure, and relationship arrows or edges connecting the nodes may represent state information related to each node.

The scene graph 100 may express relationships between objects by using the relationship arrows or edges that represent various positional relationships, such as in, on, at, and the like. The scene graph 100 may be generated, for example, through multi-view images, red, green, blue-depth (RGB-D) data, and point clouds.

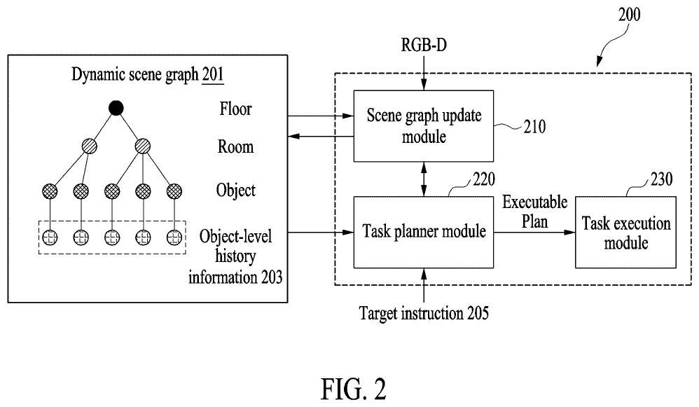

FIG. 2 illustrates an example of a method of controlling a robot by using a dynamic scene graph. Referring to FIG. 2, a diagram is illustrated showing a process in which a robot control device 200 controls a robot by using object-level history information 203 included in a dynamic scene graph 201.

The dynamic scene graph 201 may be initially generated by a robot moving through a certain space using light detection and ranging (LiDAR) and/or an RGB-D camera to generate a map of a surrounding environment and simultaneously estimating a position of the robot.

The dynamic scene graph 201 may be a data structure that expresses objects and relationships associated with the objects in a 3D environment. Unlike a static scene graph, the dynamic scene graph 201 may include a dynamic element of a scene, which changes over time. The robot control device 200 may track how a state of an object including a position changes over time through the dynamic scene graph 201. In addition, the robot control device 200 may express relationships (e.g., adjacency and inclusion relationships) between objects through the dynamic scene graph 201.

The dynamic scene graph 201 may express one scene by dividing the one scene into three layers, for example, a floor of a building, a room, and an object. The dynamic scene graph 201 may, in addition to the three layers described above, add the object-level history information 203 to all or part of object nodes corresponding to each object, as indicated by a dotted line shown in the dynamic scene graph 201. The object-level history information 203 may include a previous state of a target object, an instruction (or a command) (e.g., “a first instruction”) previously executed in response to the target object, time information corresponding to the first instruction, and a previous user that issued the first instruction. The “first instruction” herein may refer to the instruction previously executed in response to the target object. The previous state of the target object may include, but is not necessarily limited to, at least one of a previous position coordinate of the target object, a previous direction of the target object, and/or a positional relationship (e.g., up, down, inside, and outside) with at least one other object located in a same space as the target object.

The robot control device 200 may include a scene graph update module 210, a task planner module 220, and a task execution module 230.

The scene graph update module 210 may generate and/or update the dynamic scene graph 201 based on RGB-D data. The scene graph update module 210 may investigate a given environment or scene to generate the dynamic scene graph 201 or may load the dynamic scene graph 201 that has already been generated. The scene graph update module 210 may recognize objects included in an image corresponding to a corresponding space and generate the dynamic scene graph 201 by structuring relationship information between the objects and state information of each object in a graph form. In addition, the scene graph update module 210 may add, to the dynamic scene graph 201, the object-level history information 203 corresponding to each object node of the dynamic scene graph 201 based on RGB-D data. Here, the “RGB-D data” may correspond to data combining color information (i.e., RGB) and depth information (i.e., D). The depth information may be obtained (e.g., generated) through stereo vision, structured light, and/or a time of flight (ToF) sensor. The RGB-D data may be obtained by an RGB-D camera. The RGB-D camera may simultaneously provide color information and depth information of each pixel by combining a general RGB camera and a depth sensor.

The task planner module 220 may establish an executable plan for the robot to execute a target instruction 205 given by a user by referring to the dynamic scene graph 201 to which the object-level history information 203 is added.

For example, a task instruction “make a cup of coffee for Peter” may be input. In this case, the robot control device 200 may, by using the task planner module 220, appropriately plan sub-task procedures (e.g., a series of action procedures including “go to a kitchen,” “find and pick up a mug,” “go in front of a coffee machine,” “put the mug under the coffee machine,” “wait for coffee extraction from the coffee machine to be completed,” and “when the coffee extraction is completed, pick up the mug and bring the mug to a user who issued the instruction”) that the robot is to perform to complete the instruction and, based on the plan, establish an executable plan for controlling the robot.

The task planner module 220 may transmit the established executable plan to the task execution module 230 such that the robot may execute the instruction.

Referring to FIG. 2, for the ease of description, the scene graph update module 210 and the task planner module 220 are configured as separate modules, but examples are not necessarily limited thereto. The scene graph update module 210 and the task planner module 220 may be configured as a single integrated module.

The task execution module 230 may perform an operation according to the executable plan.

In the example of FIG. 2, for ease of description, it is illustrated that the scene graph update module 210, the task planner module 220, and the task execution module 230 are all included in the robot control device 200, but depending on the example, the scene graph update module 210 and the task planner module 220 may be included in the robot control device 200, and the task execution module 230 may be the robot itself or included in the robot. Further, in one or more other non-limiting examples, the robot control device 200 and the robot may be separate devices, the robot control device 200 may be the robot, the robot control device 200 may include the robot, or the robot may include the robot control device 200.

The robot control device 200 may be, for example, a server, a cloud server, an artificial intelligence agent of a large language model or a neural network model, and/or may be the robot itself.

The robot may include a sensor module, a processor, a communication device, a driving device, and/or a power supply device. The sensor module may include, for example, a camera (or an image sensor or a vision sensor) that captures images of the surrounding environment and is used for object recognition and path planning, LiDAR that uses a laser to generate a 3D environment map and accurately measures a distance and a position of an object, a radar that provides information on a speed and a distance of an object, an ultrasonic sensor that detects a close-range obstacle, an inertial measurement unit (IMU) that measures an acceleration and a rotational speed of the robot to track a movement, and/or a voice sensor that detects a voice of the user for speaker identification.

The processor may include, but is not necessarily limited to, a central processing unit (CPU) for processing sensor data, a graphics processing unit (GPU) for graphic processing, and a customized hardware device (e.g., a field-programmable gate array (FPGA) and an application-specific integrated circuit (ASIC)) for quickly processing a specific task. The operations of the scene graph update module 210 and the task planner module 220 described above may also be performed by the processor of the robot.

The communication device may include Wi-Fi and/or Bluetooth for performing data communication between the robot and an external device, a fifth-generation (5G) module for supporting a real-time control and remote monitoring through high-speed data transmission, and the like. The driving device may include various motors (e.g., an electric motor, a hydraulic motor, and a pneumatic motor) that control the movement of the robot, and an actuator (e.g., a linear actuator and a rotary actuator) that generates linear and rotary motions of an arm or other moving parts of the robot, a reducer that reduces a rotational speed of a motor and increases torque, an encoder that measures a rotational angle and speed of a motor to provide feedback, and a controller that controls the motor, actuator, reducer, and encoder. The operation of the task execution module 230 described above may be performed by the driving device of the robot.

The power supply device may include a battery, which is a main energy source that supplies power to the robot, and a power management system that manages an efficient use and charging of the battery.

A typical robot control is simply for an execution of a current instruction and does not consider a past instruction history. On the contrary, according to an example, the robot and/or robot control device 200 of one or more embodiments may execute an instruction that is performed with knowledge on a previous state and a previous instruction of an object by using the dynamic scene graph 201 with memory augmented by the object-level history information 203, and may also execute an instruction personalized according to the user based on information identified through the object-level history information 203.

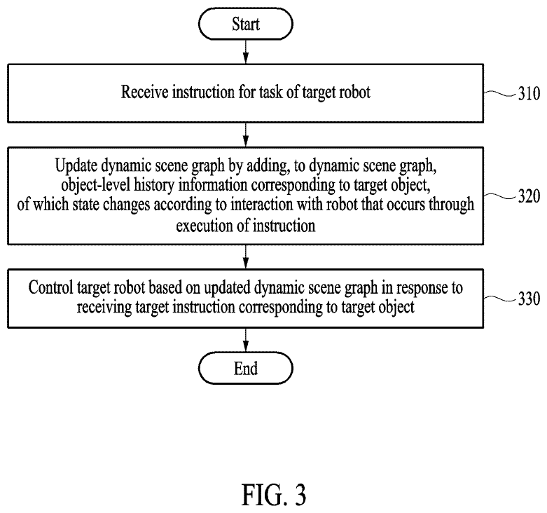

FIG. 3 illustrates a flowchart of an example of a robot control method. Operations 310 to 330 in the example of FIG. 3 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 3, a robot control device may control a target robot through operations 310 to 330. The robot control device (e.g., the robot control device 200 of FIG. 2) may be, for example, a server (or a cloud server), the target robot itself, a device included in the target robot, a device including the target robot, and/or a separate electronic device for controlling the target robot.

In operation 310, the robot control device may receive an instruction for a task of a target robot. The “target robot” may refer to a robot that is a subject of executing the instruction and may perform an operation according to the received instruction.

In operation 320, the robot control device may update a dynamic scene graph by adding, to the dynamic scene graph, object-level history information corresponding to the target object, of which a state may change according to an interaction with the robot that occurs through an execution of the instruction received in operation 310. Here, the “state” that may change according to the interaction may be understood to include not only a simple positional movement, but also various forms of change that may be made with respect to the target object, such as a change in a sound volume and/or a channel of a TV, a change in the user, a change in the surrounding environment and the like.

The “target object” may be understood to include not only a target object of which a state changes directly according to an interaction with the robot that occurs through an execution of the instruction but also at least one other object of which a state changes together with the target object due to a relationship with the target object.

The history information may include at least one of a previous state of the target object, a first instruction previously executed in response to the target object, time information corresponding to the first instruction, and/or a previous user that issued the first instruction. The previous state of the target object may include at least one of a previous position coordinate of the target object, a previous direction of the target object, and/or a positional relationship with at least one other object located in a same space as the target object. The time information corresponding to the first instruction may include information on a time at which the first instruction was transferred and/or a time at which the first instruction was executed by the robot. The time information corresponding to the first instruction may be expressed, for example, in a form of a timestamp, which is a mark that records a time at which a specific event or data occurred. The timestamp may be provided mainly in a form of a date and time.

The robot control device may update the dynamic scene graph by adding, to an object node, history information of at least one other object of which a state changes together with the target object due to an interaction with the robot that occurs through the execution of an instruction in a form of an attribute. Here, the object node may correspond to the target object in the dynamic scene graph. The history information of the at least one other object may include at least one of a previous state of the at least one other object, a second instruction previously executed in response to the at least one other object, time information corresponding to the second instruction, and a previous user that issued the second instruction. The previous state of the at least one other object may include at least one of a previous position coordinate of the at least one other object, a previous direction of the at least one other object, and/or a positional relationship between the at least one other object and the target object. The at least one other object may be one or more than one. In this specification, the “second command” may refer to an instruction previously executed in response to the at least one other object, of which a state changes together with the target object due to an interaction with the robot.

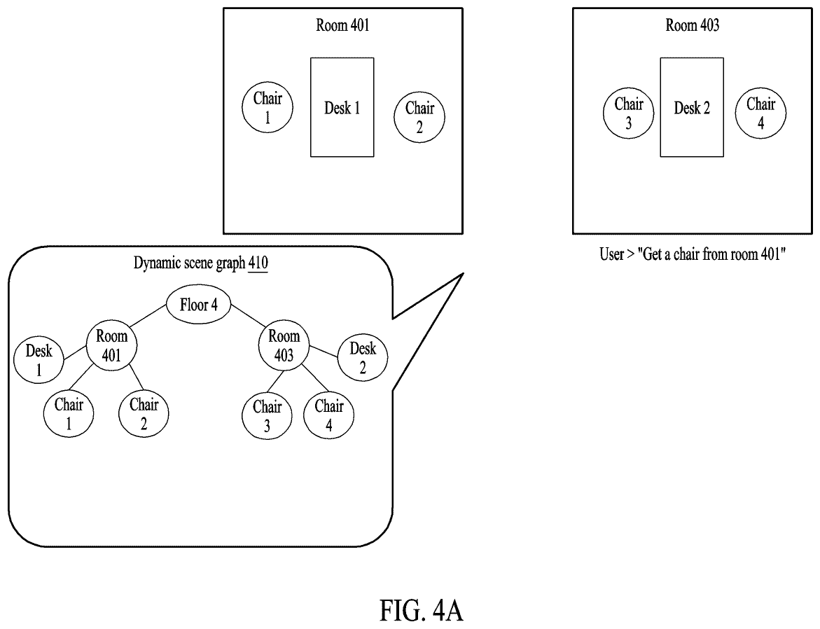

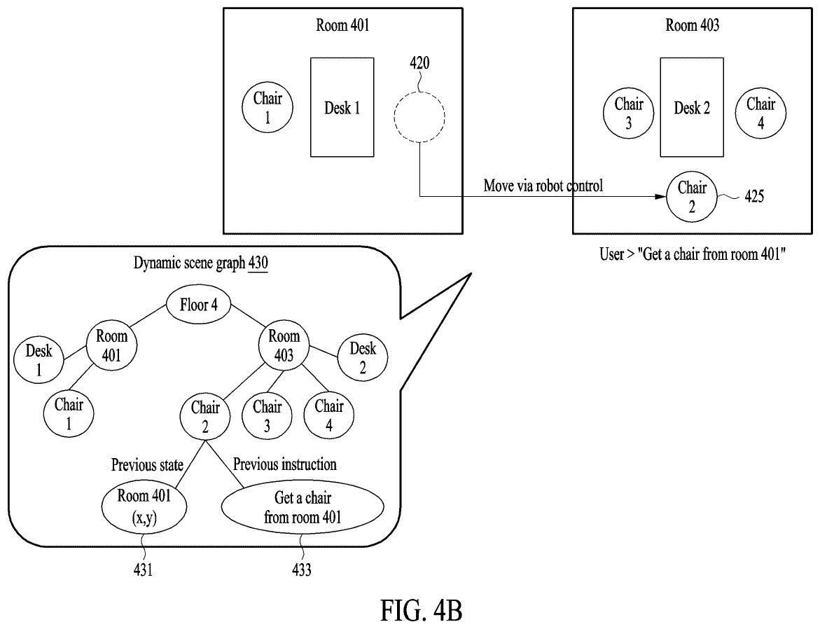

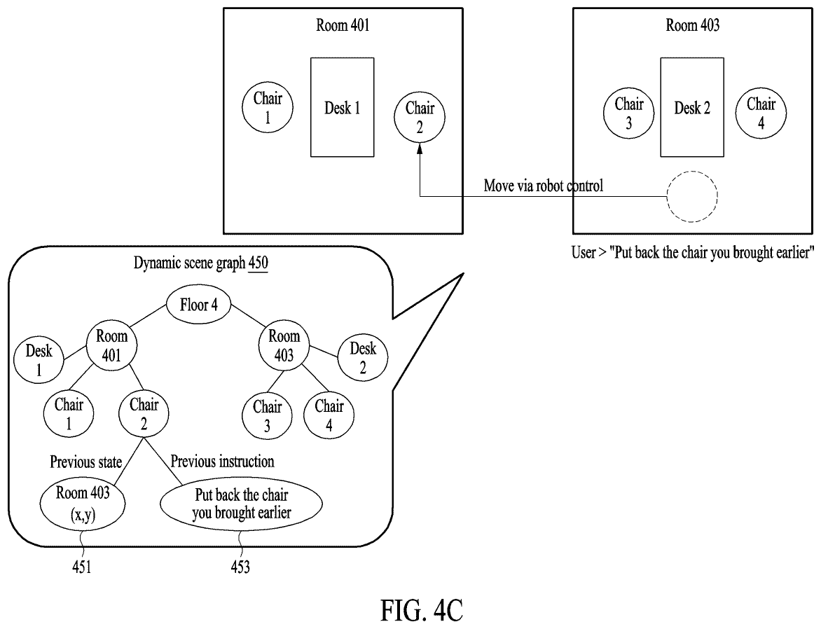

An example of a method of controlling the robot by the dynamic scene graph reflecting the history information of the at least one other object, of which a state changes together with the target object due to the interaction with the robot, when controlling the target robot is described in more detail with reference to FIGS. 4A to 4C, 5A to 5F, and 8A and 8B below.

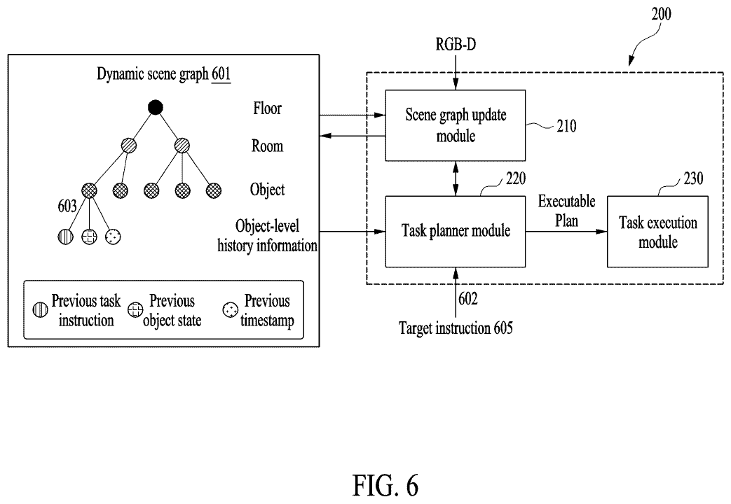

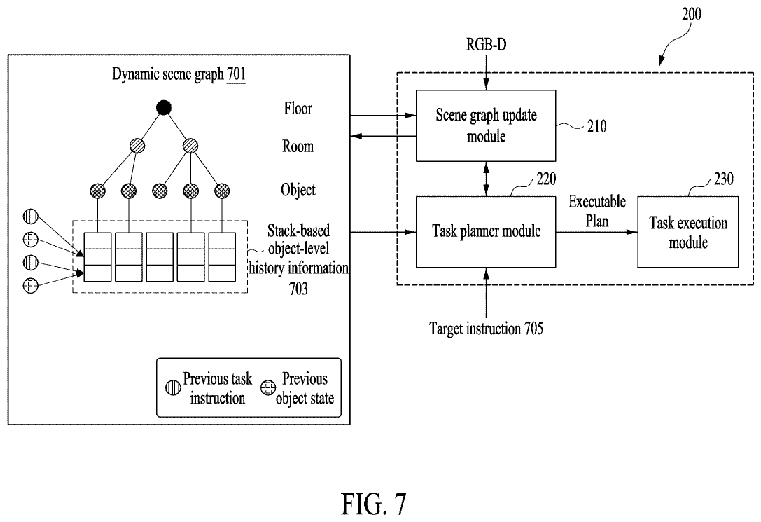

In addition, the robot control device may include only most recent history information in the object-level history information or may include accumulated history information from the past to the present. The robot control device may store the history information in a plurality of slots of an object node corresponding to the target object in the dynamic scene graph in a form of a stack data structure. An example of a method of controlling the robot by a dynamic scene graph including only the most recent history information is described in more detail with reference to FIG. 6 below. In addition, an example of a method of controlling the robot by a dynamic scene graph storing the history information in a plurality of slots in a form of a stack data structure is described in more detail with reference to FIG. 7 below.

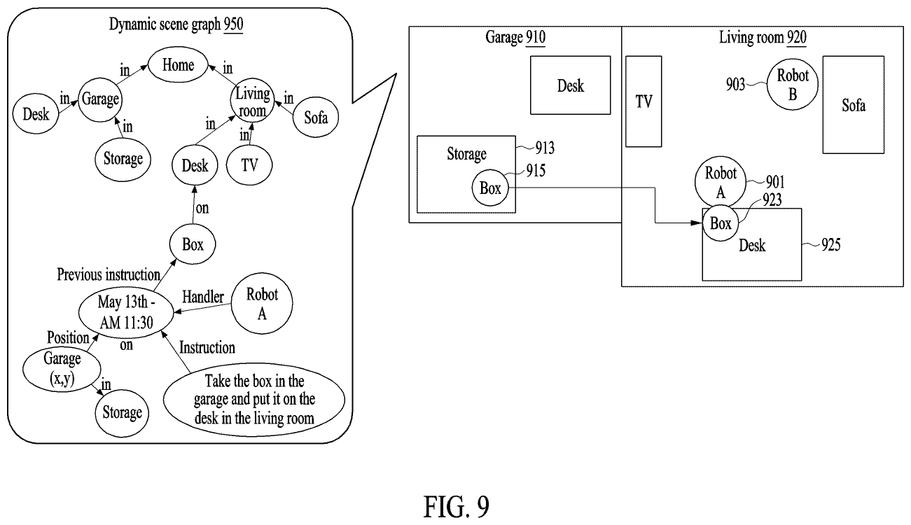

According to an example, when another robot performs a different task in a space in which a target robot executes a target instruction, the robot control device may update the dynamic scene graph by adding information on the target robot that executed the target instruction to the history information corresponding to the target object and may share the updated dynamic scene graph with other robots. An example of a method in which multiple robots may process an instruction of a user while coexisting in a same space is described in more detail with reference to FIG. 9 below.

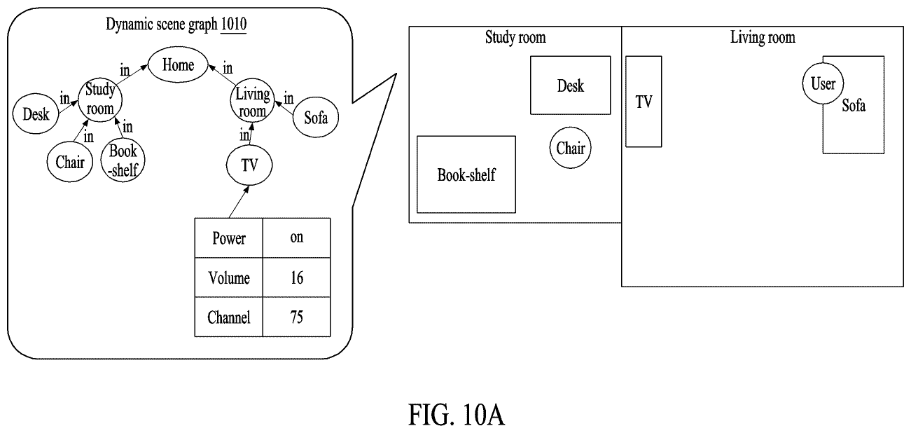

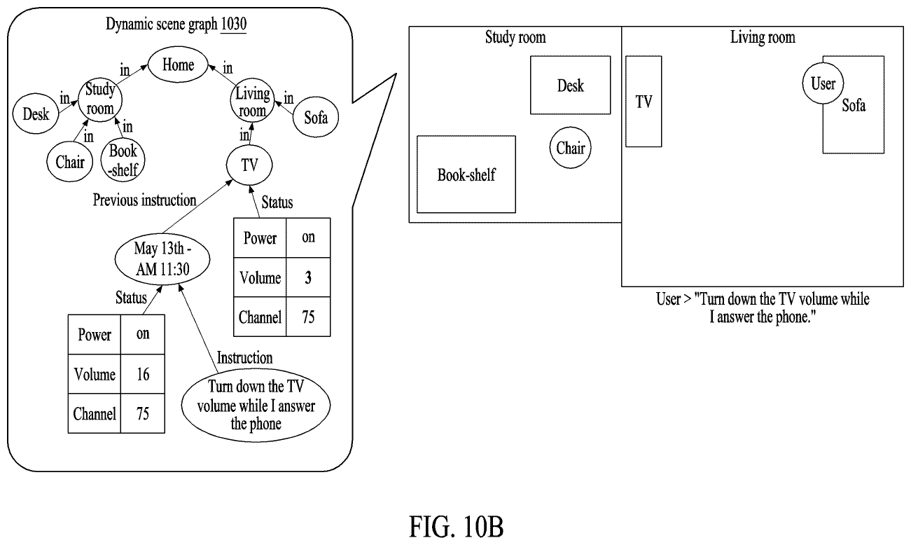

In addition, the target instruction may cause various state changes to the target object other than the position. An example of the method of controlling the robot by reflecting the state changes other than the position caused by the target instruction to the dynamic scene graph is described in more detail with reference to FIGS. 10A and 10B below.

The robot control device may recognize a voice of a user corresponding to the target instruction. In this case, the robot control device may update the dynamic scene graph by adding information on the user whose voice has been recognized to the history information corresponding to the object node in the dynamic scene graph.

In operation 330, the robot control device may control the target robot based on the dynamic scene graph updated in operation 320 in response to receiving the target instruction corresponding to the target object.

The “target instruction” may refer to an instruction based on a history of the target object and/or an instruction that involves the history of the target object for execution. The target instruction may include at least one of an instruction in a form of text or an instruction in a form of voice, for a task of the target robot. The robot control device may supplement a missing information item missing from the target instruction, based on the dynamic scene graph updated in operation 320 and may control the target robot according to the instruction with the information item supplemented. For example, when the target instruction is “bring a chair placed here to a previous position,” information indicating the previous position of the chair may not be included in the target instruction. In this case, the robot control device may determine from history information corresponding to the chair that the previous position of the chair is a “living room” and a current position of the chair is a “room.” The robot control device may generate a supplemented instruction by supplementing, using the history information, the previous position (e.g., the living room) and the current position (e.g., the room), which may be the missing information items in the target instruction, and may control the target robot according to the supplemented instruction.

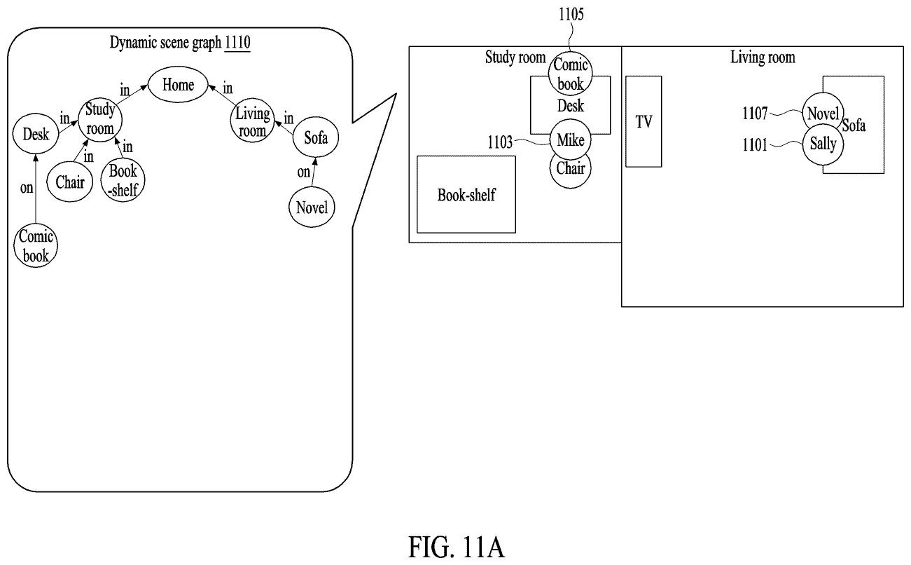

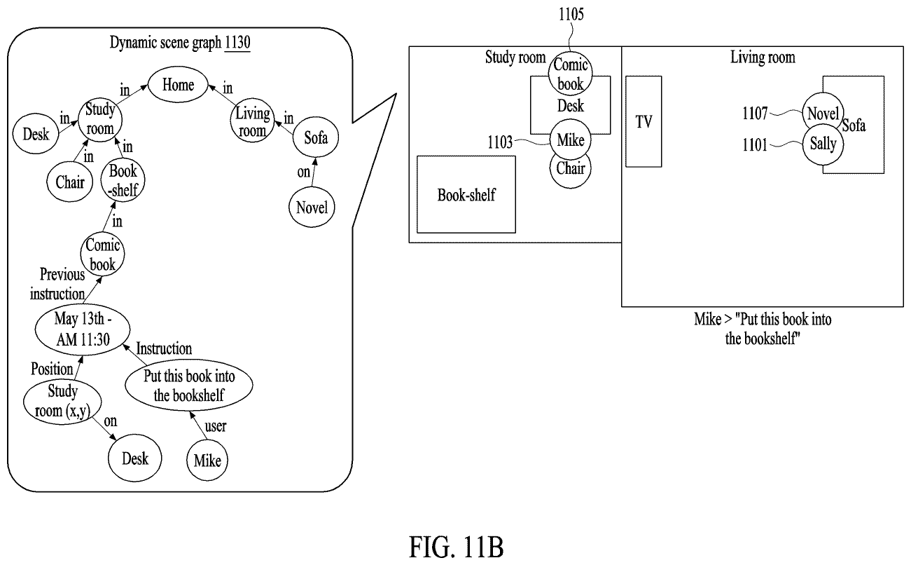

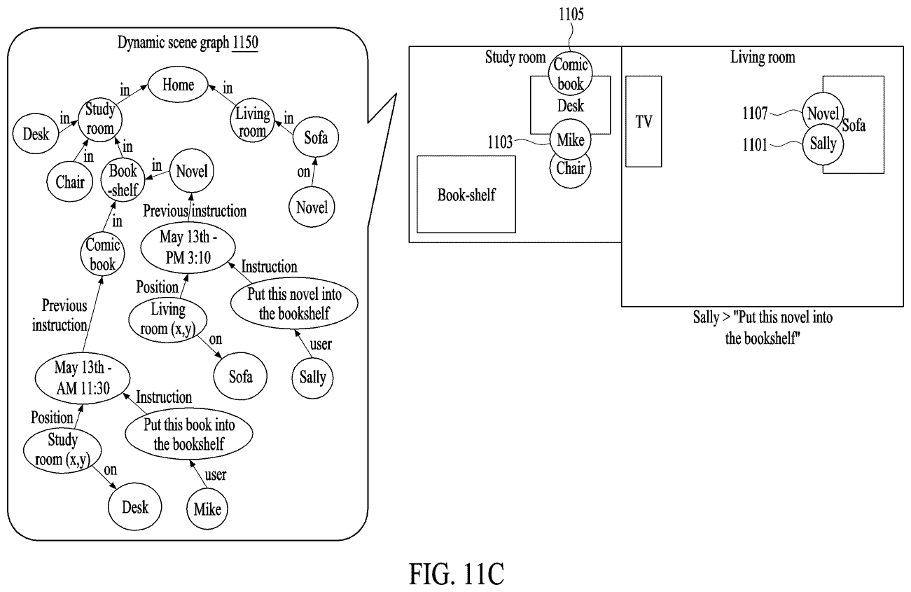

In operation 320, when the dynamic scene graph is updated by information on the user whose voice has been recognized, the robot control device may control the target robot to execute the target instruction for the user whose voice has been recognized. An example of a method in which the robot control device recognizes the speaker of an instruction and provides personalized robot control is described in more detail below with reference to FIGS. 11A to 11C.

FIGS. 4A to 4C illustrate an example of a method of controlling a robot by using a dynamic scene graph with augmented object-level history information.

Referring to FIGS. 4A to 4C, a process of controlling a robot, when controlling a target robot, by a dynamic scene graph reflecting history information on at least one other object of which a state has changed due to an interaction between the target robot and a target object is illustrated.

For example, as shown in FIG. 4A, there may be one desk (Desk 1) and two chairs (Chair 1 and Chair 2) in room 401 located on a 4th floor, and there may be also one desk (Desk 2) and two chairs (Chair 3 and Chair 4) in room 403 located on the 4th floor.

A dynamic scene graph 410 corresponding to a situation like FIG. 4A may be configured in a form in which room nodes corresponding to each of rooms 401 and 403 are connected to a node corresponding to the 4th floor, and object nodes corresponding to each of one desk and two chairs are connected to each room node. Here, a situation may arise in which an additional chair is needed for three people to conduct a meeting in room 403. A user may request an instruction such as “Get a chair from room 401 (Bring a chair from room 401)” from the robot.

In this case, the robot may randomly select one of the two chairs in room 401 (e.g., a chair 2 420) as shown in FIG. 4B and bring the chair 2 420 to room 403. By this operation of the robot, the chair 2 420 in room 401 may be moved to a chair 2 425 in room 403.

A previous state and a previous instruction for the object (e.g., the chair 2 425) moved to room 403 through the operation of the robot may be added to an object node corresponding to the target object (e.g., the moved chair 2 425) of which a state changes due to an interaction with the robot, as in a dynamic scene graph 430, and stored (or recorded) together with a previous state node 431 and a previous instruction node 433. The previous state node 431 may store a position (x, y) in room 401, which is a previous position of the moved chair 2 425 (e.g., a position of the chair 2 420 in room 401). Here, the position (x, y) may include not only simple position coordinates but also relative positional relationships with other objects. In addition, the previous instruction node 433 may store the previous instruction (e.g., “Get a chair from room 401.”) corresponding to the moved chair 2 425.

After the meeting is over, the user may issue an instruction to the robot, such as “Put back the chair you brought earlier” as shown in FIG. 4C, to return the chair that the robot brought to an original position (e.g., room 401). By an operation according to the instruction, the position of the chair 2 425 in room 403 may be changed back to the chair 2 420 in room 401. Here, even when a target of an instruction for the robot is ambiguous, such as in “the chair that was brought earlier,” the robot and/or robot control device of one or more embodiments may accurately accomplish the ambiguous target by searching history of objects stored in the dynamic scene graph 430 to determine that the target object is the chair 2 425 and executing the instruction.

A robot control device (e.g., the robot control device 200 of FIG. 2) may store (or record) the previous state and the previous instruction of the target object (e.g., the chair 2 420) that has been moved back to room 401 by the operation of the robot according to the instruction, by adding a previous state node 451 and a previous instruction node 453 to an object node corresponding to the corresponding object (e.g., the chair 2 420) as in a dynamic scene graph 450. Here, the previous state node 451 may store a position (x, y) in room 403, which is a previous position of the chair 2 420 that has been moved back to room 401. In addition, the previous instruction node 453 may store the previous instruction (e.g., “Put back the chair you brought earlier”) corresponding to the chair 2 425 that has been moved back to room 401.

Even when a simplified or ambiguous instruction such as “Put back the chair you brought earlier” is received, the robot and/or robot control device of one or more embodiments may generate a supplemented instruction (e.g., “Move this chair to room 401, to an empty space opposite the chair 1 ”) based on the dynamic scene graph 430 by supplementing the missing information items (e.g., a target of the movement (the chair 2 425) and a position of the movement (the empty space opposite the chair 1 in room 401)) in the simplified instruction (e.g., “Put back the chair you brought earlier”). Thus, even when receiving an instruction with an ambiguous target, by generating the supplemented instruction, the robot and/or robot control device of one or more embodiments may execute the instruction more accurately than a typical robot and/or control device that does not generate the supplemented instruction.

By controlling the robot based on the history information that changes in the dynamic scene graph, the robot and/or robot control device of one or more embodiments may simply an instruction of the user while alleviating a problem of hallucination that may occur when an artificial intelligence (AI) system generates information that does not actually exist or outputs distorted data when controlling the robot.

In addition, by storing the object-level history information in the object node of the dynamic scene graph, the robot and/or robot control device of one or more embodiments may performed memory read/write only for a small number of objects of interest, thereby reducing the use of memory used to store states and instructions of all objects included in a certain space for each time information (e.g., timestamp), and improving the processing speed.

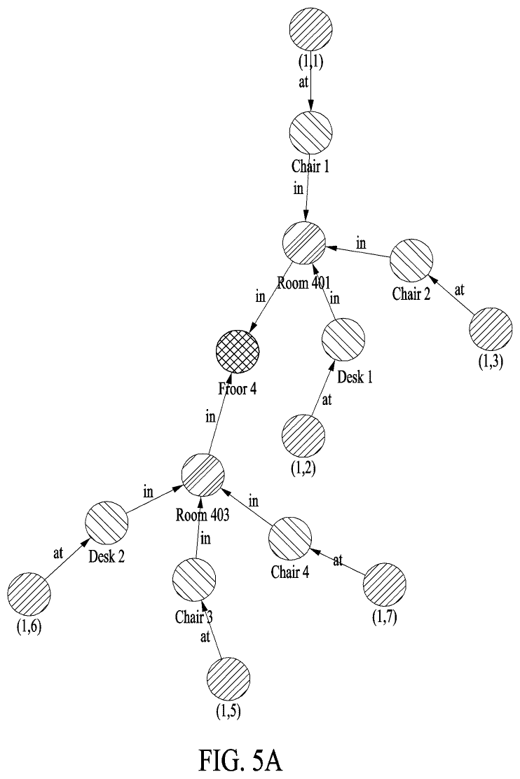

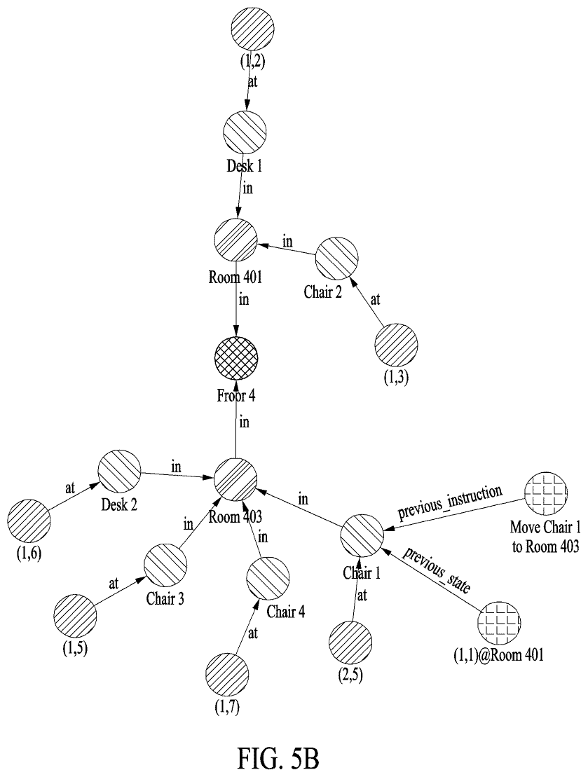

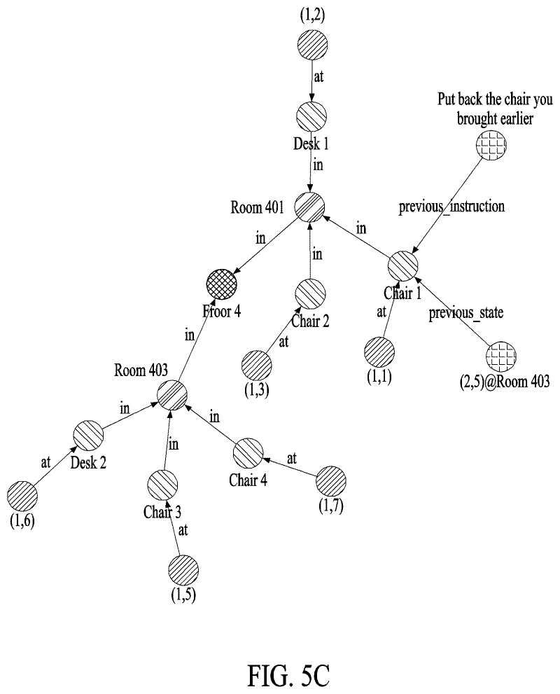

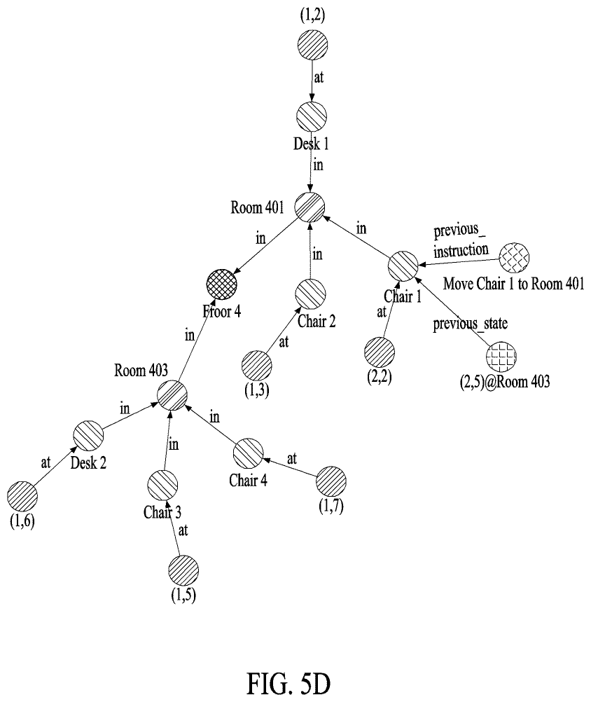

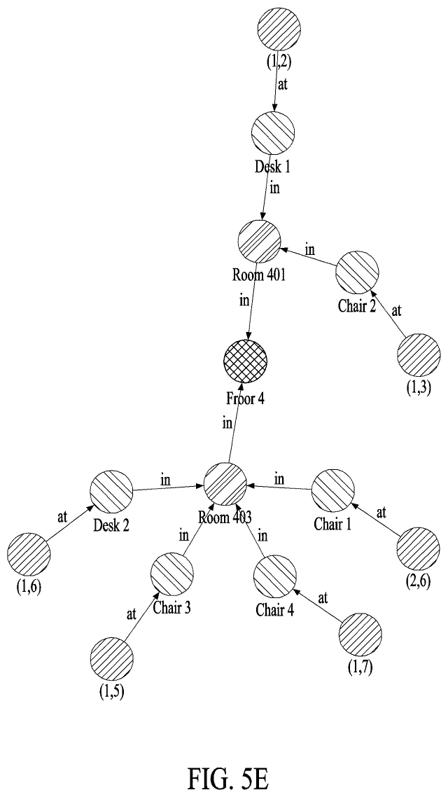

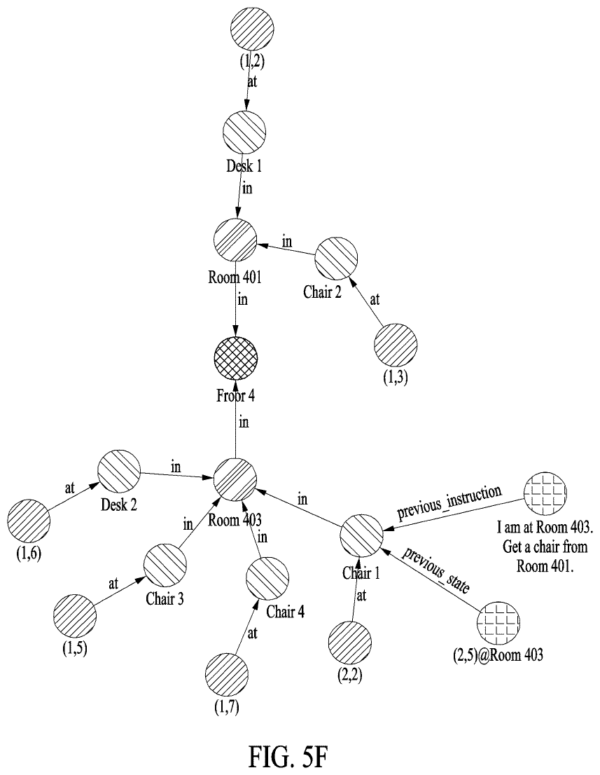

FIGS. 5A to 5F illustrate an example of a process in which a dynamic scene graph changes during an execution of a target instruction. Referring to FIGS. 5A to 5F, a process in which the dynamic scene graph changes according to a change in an instruction of a user input in a form of a prompt is illustrated.

For example, as shown in FIG. 4A, there may be one desk (Desk 1) and two chairs (Chair 1 and Chair 2) in room 401 located on the 4th floor, and similarly, there may be one desk (Desk 2) and two chairs (Chair 3 and Chair 4) in room 403 located on the 4th floor. In this situation, the dynamic scene graph may be initialized as shown in FIG. 5A.

In this case, the user may start controlling the robot by inputting a prompt to a large language model (LLM).

For example, when the user inputs a prompt such as “Move Chair 1 to Room 403” to the LLM, the LLM may convert the prompt into an instruction for the robot and transfer the instruction, such that the robot may execute the instruction (e.g., “Move Chair 1 to Room 403”).

A robot control device may reflect a result of the execution of the instruction (e.g., “Move Chair 1 to Room 403”) by the robot in the dynamic scene graph as shown in FIG. 5B. According to the execution of the instruction by the robot, Chair 1 may be moved to a sub-node of Room 403 in the dynamic scene graph of FIG. 5B. In this case, a previous state (“(1,1)@Room 401”) and a previous instruction (“Move Chair 1 to Room 403”) of the target object (e.g., Chair 1), of which a state changes due to an interaction with the robot that occurs through an execution of the instruction, may be stored in a sub-node of the moved Chair 1.

Subsequently, when the user inputs a prompt such as “Put back the chair you brought earlier” to the LLM, the LLM may convert the prompt into an instruction for the robot and transmit the instruction, such that the robot may execute the instruction (e.g., “Put back the chair you brought earlier”). The robot control device may reflect a result of an execution of the instruction (“Put back the chair you brought earlier”) by the robot in the dynamic scene graph as shown in FIG. 5C. According to the execution of the instruction by the robot, a previous state (“(2,5)@Room 403”) and a previous instruction (“Put back the chair you brought earlier”) may be stored in a sub-node corresponding to Chair 1 in the dynamic scene graph of FIG. 5C.

When the instruction “Move Chair 1 to Room 401” is simply input as a prompt, without a separate instruction to put Chair 1 back to the previous location as in “Put back the chair you brought earlier“ in FIG. 5C, the robot may put Chair 1 to any location in Room 401 according to the instruction (“Move Chair 1 to Room 401”). In this case, the robot control device may store the previous state (“(2,5)@Room 403”) and the previous instruction (”Move Chair 1 to Room 401”) in the sub-node corresponding to Chair 1 in the dynamic scene graph, as shown in FIG. 5D.

Here, when history information such as the previous state and the previous instruction is not added to the sub-node corresponding to Chair 1 in the dynamic scene graph, as shown in FIG. 5C or FIG. 5D, the robot may not properly understand the instruction “Put back the chair you brought earlier.” This may correspond to a case in which the robot does not additionally remember the previous state and the previous command in FIG. 5B. Without knowing the original location of Chair 1, the robot control device may perform an arbitrary, unpredictable action in response to the instruction “Put back the chair you brought earlier,” due to the Hallucination problem of the LLM. For example, as shown in FIG. 5E, the robot may move Chair 1 from (2,5) in Room 403 to an arbitrary position (2,6) in Room 403, instead of moving Chair 1 to Room 401, in which the Chair 1 was originally located, as shown in FIG. 5E.

For another example of utilizing a memory-augmented dynamic scene graph, when a user inputs an instruction such as “I am at Room 403. Get a chair from Room 401” as a prompt to the LLM, the LLM may convert the prompt into an instruction for the robot and transfer the instruction, such that the robot may execute the instruction (“I am at Room 403. Get a chair from Room 401”). The robot may then bring Chair 1 to Room 403 according to the instruction. The robot control device may then reflect a result of the execution of the instruction (“I am at Room 403. Get a chair from Room 401”) by the robot to the dynamic scene graph, as shown in FIG. 5F. According to the execution of the instruction by the robot, the robot control device may store the previous state (“(2,5)@Room 403”) and the previous instruction (“I am at Room 403. Get a chair from Room 401”) as history information corresponding to Chair 1 in the sub-node of Chair 1 belonging to Room 403 in the dynamic scene graph of FIG. 5F. The robot control device may control the robot to execute an instruction based on the history, by reflecting a state change of a target object (e.g., Chair 1) caused by the interaction with the robot as history information, which may be changed in the dynamic scene graph as shown in FIG. 5A to FIG. 5F when controlling the target robot.

FIG. 6 illustrates an example of an operation of a robot when a dynamic scene graph stores a most recent history. Referring to FIG. 6, a drawing is illustrated showing a process in which the robot control device 200 controls the robot by using most recent object-level history information 603 included in a dynamic scene graph 601. The robot control device 200 may include only the most recent history information in the object-level history information 603 of the dynamic scene graph 601 or may cumulatively include accumulated history information from a determined point in the past to the present.

For example, it may be assumed that the object-level history information 603 includes only the most recent history information, such as a previous task instruction, a previous object state, and a previous timestamp.

The robot control device 200 may initially investigate a given environment and generate a dynamic scene graph by the scene graph update module 210 or may be provided with an already generated scene graph.

When a user gives a target instruction 605 to the robot control device 200 through an LLM and/or a graph database, the robot control device 200 may make a plan by the task planner module 220 for executing the given instruction and perform an operation for executing the instruction.

The robot control device 200 may add the object-level history information 603 regarding the target object and at least one other object (“target object”) of which a state changes together with the target object through an interaction with the robot during a process during which the robot executes an instruction, such as moving an object, in a form of an attribute, to the object node corresponding to the target object in the dynamic scene graph 601. Here, the object-level history information 603 may be object-level history information and may include, for example, a previous task instruction, a previous object state before the instruction is executed, a current time, and/or a previous timestamp, but is not necessarily limited thereto.

When the robot control device 200 receives an instruction based on history from a user, the robot control device 200 may specifically supplement omitted information items (or missing information items) in the instruction from the user, by referring to memory information of an object, that is, the dynamic scene graph 601 dynamically modified through the above-described process, and may control a target robot by the instruction with the supplemented information items. The robot control device 200 may record an execution time of the previous task instruction in the object-level history information 603 through the previous timestamp.

Thus, the robot control device 200 may check the previous record, such as “When and why did this come here?,” and perform an instruction, such as “Return to room 402 in 1 hour,” through a timer operation through a background task.

FIG. 7 illustrates an example of managing object-level history information in a form of a stack data structure. Referring to FIG. 7, a drawing is illustrated showing a process in which the robot control device 200 controls a robot by storing object-level history information 703 in a form of a stack data structure in a plurality of slots of an object node corresponding to a target object in a dynamic scene graph 701.

The robot control device 200 may manage not only the most recent history but also accumulated history for the most recent “n” slots by storing the object-level history information 703 in the form of a stack data structure in the plurality of slots corresponding to the object node corresponding to the target object.

The robot control device 200 may store the history over multiple times (e.g., “n” slots) together by the stack-based object-level history information 703, such that a target instruction 705 may execute a query or an instruction based on statistics according to a past history, such as “Where is this chair mainly located? Move it there,” by the object-level history information 703 without separate additional information. The robot control device 200 may identify an average position of the chair (or a most common (e.g., most frequently occurring) position among previous positions of the chair) by the past history stored in the stack-based “n” slots and may perform the target instruction 705 by moving the chair to the average position (or the most common position).

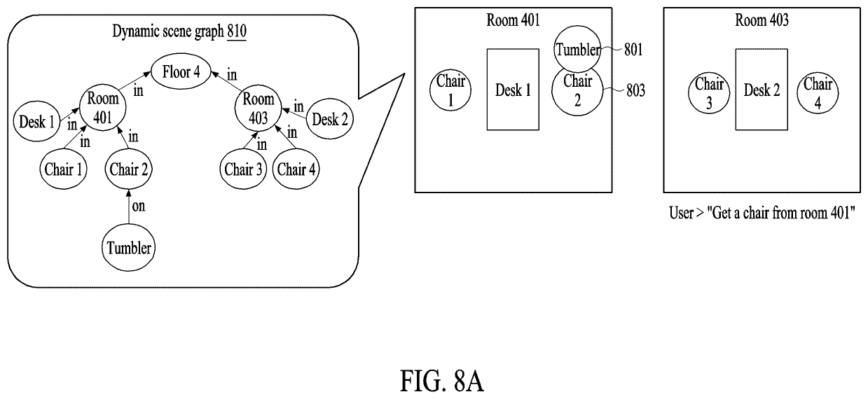

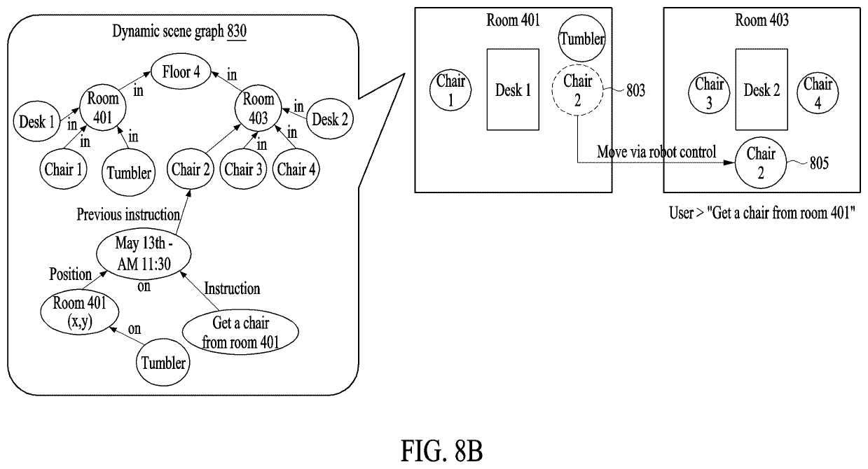

FIGS. 8A and 8B illustrate an example of a method in which a target robot remembers a relationship with one or more other objects through a dynamic scene graph when operating.

Referring to FIGS. 8A and 8B, an operation of the robot and a change in a dynamic scene graph 810 according to the operation in a case an instruction to bring a chair (e.g., Chair 2) 803 is received in a situation in which a tumbler 801 is placed on the chair (e.g., Chair 2) 803 in room 401 are illustrated.

As shown in FIG. 8A, when the tumbler 801 is placed on the chair (e.g., Chair 2) 803 in room 401, a situation may arise in which three people need an additional chair for a meeting in room 403. A user may issue an instruction such as “Get a chair from room 401” to the robot. In this case, the robot may move a position of the chair in room 401 to room 403 by executing the instruction. The robot control device may store object-level history information corresponding to the target object of which a state changes due to an interaction with the robot that occurs through the execution of the instruction in the dynamic scene graph 810.

The robot control device may add the history information of another object (e.g., the tumbler 801) of which a state changes together with the target object (e.g., the chair (e.g., Chair 2) 803) due to the interaction with the robot that occurs through the execution of the instruction in a form of an attribute to an object node corresponding to the target object (e.g., the chair (e.g., Chair 2) 803).

The robot control device may control the tumbler 801 to return to an original position on the chair (e.g., Chair 2) 803 when the robot returns the chair (e.g., Chair 2) 803 from room 403 back to room 401 by remembering a positional relationship between objects in room 401 in the dynamic scene graph 810.

For example, according to the instruction “Get a chair from room 401,” the robot may move the chair (e.g., Chair 2) 803 to the position of the chair (e.g., Chair 2) 805 in room 403, as shown in FIG. 8B. Accordingly, the robot control device can place the tumbler 801 on the chair (e.g., Chair 2) 803 in an empty space of room 401, and store the information that the tumbler 801 was on the chair (e.g., Chair 2) 803 as the history information of the dynamic scene graph 830 of FIG. 8B.

The robot control device may store a snapshot of a positional relationship between objects in room 401 before executing the instruction (“Get a chair from room 401”) as the history information corresponding to the chair (e.g., Chair 2) 803 in the dynamic scene graph 810, thereby enabling the positional relationship between objects to be more clearly identified. The robot control device may remember the positional relationship between objects in room 401 by storing the time (“May 13th—AM 11:30”) at which a previous instruction was executed, the previous instruction (“Get a chair from room 401”), the previous position (Room 401(x, y)) of the object (“Chair 2 ”), and the relationship (“on”) with another object (“Tumbler”) related to the object, in a sub-node of the chair (“Chair 2 ”) belonging to a room node corresponding to room 403 in the dynamic scene graph 830. Thereafter, when the robot returns the position of the chair (“Chair 2 ”) from room 403 to room 401, the robot may place the tumbler 801 that was temporarily placed nearby back on the chair (“Chair 2 ”) 803. As another example, in response to the instruction “Get a chair from room 401,” the robot may select, from among a plurality of target objects (e.g., Chair 1 and Chair 2) in room 401, a target object (e.g., Chair 1) of which history information of another object of which a state changes together with the target object is not included in the dynamic scene graph, and may move the selected target object (e.g., Chair 1) to the position of the chair (e.g., Chair 2) 805 in room 403, thereby moving the target object that is free of the obstructing other object (e.g., the tumbler).

FIG. 9 illustrates an example of a method in which a target robot processes an instruction of a user while coexisting in a same space as another robot. Referring to FIG. 9, a situation is illustrated in which a target robot, robot A 901, coexists with robot B 903 in a home including a garage 910 and a living room 920.

A user may transfer an instruction, such as “Take the box in the garage and put it on the desk in the living room” to the robot A 901 located in the living room 920. The robot A 901 may move a box 915 in a storage 913 of the garage 910 to a location of a box 923 on a desk 925 in the living room 920 according to the instruction of the user.

In this case, the robot control device may update a dynamic scene graph 950 by adding information on the target robot (the robot A 901) that executed the target instruction to history information corresponding to the box 923 by recording the robot A 901 that executed the target instruction as a “Handler” in the dynamic scene graph 950. The robot control device may share the dynamic scene graph 950 with updated information on the target robot (the robot A 901) with other robots 903. In addition to information on the target robot (the robot A 901) that executed the target instruction, the dynamic scene graph 950 may also store the time (“May 13th—AM 11:30”) at which a previous instruction corresponding to the target object (e.g., the box 923) was executed, a previous position of the target object (“Garage(x, y)”), a relationship (“in”) with another object (e.g., the storage 913) related to the previous position (“Garage(x, y)”) of the target object, and the previous instruction (“Take the box in the garage and put it on the desk in the living room”).

FIGS. 10A and 10B illustrate an example of an operation when a target instruction causes various state changes other than a positional change of a target object. Referring to FIGS. 10A and 10B, an operation of the robot and a resulting change in a dynamic scene graph in a case a user sends an instruction to a robot, “Turn down the TV volume while I answer the phone,” in a home including a study room and a living room are illustrated.

When the home includes a study room and a living room, a dynamic scene graph 1010 as in FIG. 10A may include nodes corresponding to objects (e.g., a desk, a chair, and a bookshelf) included in the study room and nodes corresponding to objects (e.g., a TV and a sofa) included in the living room. In this case, status information related to the TV (e.g., power on/off status (‘On’), sound volume (‘16’), and channel (‘75’)) may be stored together in response to a TV node.

In this status, as shown in FIG. 10B, an instruction “Turn down the TV volume while I answer the phone” may be transferred to the robot by the user. The robot may turn down the TV volume to ‘3.’

According to the operation of the robot performing the command, the robot control device may store the current status information (e.g., power on/off status (‘On’), sound volume (‘3’), channel (‘75’)) corresponding to the TV, together with the previous status information (e.g., power on/off status (‘On’), sound volume (‘16’), channel (‘75’)) and the previous instruction (“Turn down the TV volume while I answer the phone”) as history information in a sub-node of the TV, which is the target object, in a dynamic scene graph 1030. In this case, the current status information and the previous status information corresponding to the TV, which is the target object, in the dynamic scene graph 1030 may be stored in different hierarchies (or depths). In other words, the current status information may be stored in a sub-node immediately below the TV, which is the target object, in the dynamic scene graph 1030. On the other hand, a previous status node may be stored in a sub-node of the execution time of the previous instruction, which is the sub-node immediately below the TV, which is the target object, in the dynamic scene graph 1030.

The robot may store original status information, such as the sound volume of the TV, as the dynamic scene graph 1030 and may use the information to control the TV when restoring the information to an original state later.

For example, when an instruction of the user is accompanied by a state change, such as ‘Raise the boiler temperature to 37 degrees’ or ‘Open the umbrella and put it on the veranda,’ it may be difficult to perform history-based control accompanied by state changes with only a position history. In addition, there may be cases in which the robot may be controlled only when the ‘instruction’ given by a specific user in the past is known. According to an example, by storing not only a history of position information of the target object but also various previous states of the target object and previously executed instructions, it may be easy to perform history-based control accompanying various state changes as well as a position history.

FIGS. 11A to 11C illustrate an example of a method of controlling a robot for each user by recognizing a speaker of a target instruction. Referring to FIGS. 11A to 11C, a method of providing personalized robot control by recognizing a speaker of a target instruction by using a dynamic scene graph when a target instruction is input in a form of voice is illustrated.

The personalized robot control based on history information may be enabled by adding information on the speaker of the target instruction, that is, the user who gave the instruction, to the history information corresponding to the target object in the dynamic scene graph through user recognition based on the voice of the user.

For example, as shown in FIG. 11A, it may be assumed that Sally 1101 and Mike 1103 live in a house Home, and on May 13, Sally 1101 is reading a novel 1107 on a sofa Sofa in a living room Living room, and Mike 1103 is sitting on a chair in a study room Study room and looking at a comic book 1105 at a desk Desk. In this case, the robot control device may generate a dynamic scene graph 1110 that represents a positional relationship between objects in each of the living room Living room and the study room Study room of the home Home.

Here, as shown in FIG. 11B, Mike 1103 in the study room Study room may give an instruction “Put this book into the book-shelf” to the robot. The robot may perform an operation of putting the comic book 1105 that Mike 1103 was reading at the desk in the study room into a bookshelf according to the instruction (“Put this book into the book-shelf”). In this case, the time at which the robot performed Mike's 1103 instruction may be “AM 11:30 .”

The robot control device may store a positional relationship (‘in’) between the comic book 1105, which is an object that is a target of a command from a microphone 1103, and the bookshelf, as a sub-node of the bookshelf in the dynamic scene graph 1130, while storing information on the execution time of a previous instruction related to the comic book 1105 (“May 13th—AM 11:30”), the previous instruction (“Put this book into the book-shelf”), the previous position of the comic book 1105 (“on the desk (Desk) in the “Study room (x, y)”), and/or the user (“the microphone 1103”) who is the speaker (or the user) of the instruction, as history information corresponding to the target object (the comic book 1105). Here, as the history information corresponding to the target object (the comic book 1105), the time information at which the instruction was executed may be preferentially stored, and then, among previous positions of the target object, the position corresponding to a wider area (e.g., the Study room (x, y)) and the previous instruction (“Put this book into the book-shelf”) may be stored in a sub-node of the time information. In addition, in the dynamic scene graph 1130, a position (or an object) corresponding to a narrow area (e.g., Desk) included in the wider area may be stored in a sub-node of the position corresponding to the wider area (e.g., Study room (x, y)), and information on the user (“Mike 1103”) who is the speaker (or the user) of the instruction may be stored in a sub-node of the previous instruction (“Put this book into the book-shelf”).

Afterwards, Sally 1101, who was in the living room as shown in FIG. 11C, may say the instruction “Put this novel into the book-shelf” to the robot.

The robot may put the novel 1107 on a sofa in the living room into the bookshelf in the study room according to the instruction. In this case, the time the robot executed Sally's 1101 instruction may be “PM 3:10”. The robot control device may store the positional relationship (‘in’) between the novel 1107, which is the target object of the command of Sally 1101, and the bookshelf in the sub-node of the bookshelf that is the target object of the instruction of Sally 1101 in a dynamic scene graph 1150, and may store the execution time of the previous command related to the target object of the novel (1107) (“May 13th—PM 3:10”), the previous command (“Put this novel into the book-shelf”), the previous location of the novel (1107) (“on the sofa in the living room (x, y)”), and/or the user (“Sally (1101)”) who is the speaker (user) of the command as the history information of the target object (“novel (1107)”). In this case, the robot can remember and bring the book that each user was reading by identifying the history information about the target object included in the command of each speaker in the dynamic scene graph 1150, even when Sally 1101 or Mike 1103 gives the same instruction to the robot, “Bring me the book I was reading yesterday.” In other words, even when the same instruction, “Bring me the book I was reading yesterday,” is transferred, when the speaker of the instruction is Sally 1101, the robot may bring the novel 1107 through the history information stored with respect to Sally 1101 in the dynamic scene graph 1150, and when the speaker of the instruction is Mike 1103, the robot may bring the comic book 1105 through the history information stored with respect to Mike 1103 in the dynamic scene graph 1150.

Even when the same instruction is given, the robot may provide personalized robot control for each speaker by recognizing the speaker of the target instruction and identifying the target object through the dynamic scene graph.

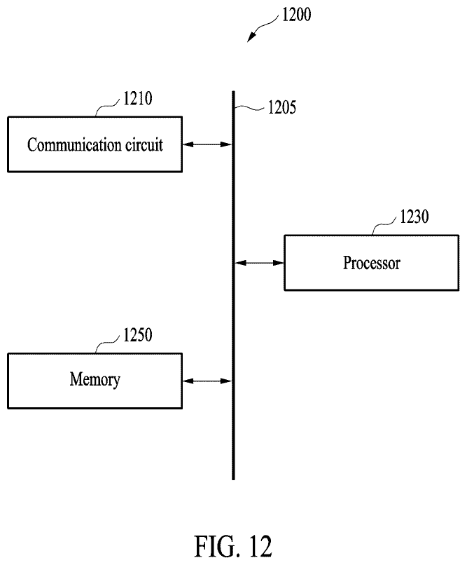

FIG. 12 illustrates an example of a robot control device. Referring to FIG. 12, a robot control device 1200 may include a communication circuit 1210, a processor 1230 (e.g., one or more processors), and a memory 1250 (e.g., one or more memories). The communication circuit 1210, the processor 1230, and the memory 1250 may be connected to each other through a communication bus 1205. Although not shown in the drawing, the robot control device 1200 may further include an LLM. The LLM may exist within the memory 1250 or may exist separately within the robot control device 1200.

The robot control device 1200 may include various computing devices such as a mobile phone, a smart phone, a tablet, an e-book device, a laptop, a personal computer (PC), a desktop, a workstation, and/or a server, various wearable devices such as a smart watch, smart glasses, a head-mounted display (HMD), and/or smart clothing, various home appliances such as a smart speaker, a smart TV, and/or a smart refrigerator, a smart car, a smart kiosk, an Internet of things (IoT) device, a WAD, a drone, and/or a robot.

The communication circuit 1210 may receive an instruction for an operation of the target robot.

The processor 1230 may update the dynamic scene graph by adding object-level history information corresponding to a target object of which state changes due to an interaction with the robot that occurs through an execution of the instruction received by the communication circuit 1210. The processor 1230 may control the target robot based on the updated dynamic scene graph as the target instruction corresponding to the target object is received through the communication circuit 1210.

The processor 1230 may be one or more, and may execute instructions or programs, and/or control the robot control device 1200. The processor 1230 may include, for example, a graphics processing unit (GPU), a neural processing unit (NPU), a tensor processing unit (TPU), and the like. In addition, depending on the example, the processor 1230 may include a central processing unit (CPU).

The processor 1230 may perform the operations mentioned above through FIGS. 1 to 11C as at least some of the instructions stored in the memory 1250 are executed by the processor 1230. For example, the memory 1250 may be or include a non-transitory computer-readable storge medium storing code that, when executed by the processor 1230, configures the processor 1230 to perform any one, any combination, or all of the operations and/or methods disclosed herein with reference to FIGS. 1-12.

The memory 1250 may store a dynamic scene graph generated and/or updated by the processor 1230.

The memory 1250 may be electrically connected to the processor 1230 and may store instructions executed by the processor 1230. The memory 1250 may store instructions executable by the processor 1230. The memory 1250 may be volatile memory or non-volatile memory.

The robot control devices, scene graph update modules, task planner modules, task execution modules, communication circuits, processors, memories, communication buses, robot control device 200, scene graph update module 210, task planner module 220, task execution module 230, robot control device 1200, communication circuit 1210, processor 1230, memory 1250, and communication bus 1205 described herein, including descriptions with respect to respect to FIGS. 1-12, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-12 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
updating a dynamic scene graph by adding, to the dynamic scene graph, object-level history information corresponding to a target object, of which a state changes according to an interaction with a robot that occurs through an execution of an instruction for a task of a target robot; and
controlling the target robot based on the updated dynamic scene graph, in response to receiving a target instruction corresponding to the target object.

2. The method of claim 1, wherein the history information comprises any one or any combination of any two or more of:
a previous state of the target object, comprising any one or any combination of any two or more of a previous position coordinate of the target object, a previous direction of the target object, and a positional relationship with one or more other objects located in a same space as the target object;
a first instruction previously performed in response to the target object;
time information corresponding to the first instruction; and
a previous user that issued the first instruction.

3. The method of claim 1, wherein the updating of the dynamic scene graph comprises updating the dynamic scene graph by adding, to an object node, history information of one or more other objects, of which a state changes together with the target object due to the interaction, in a form of an attribute, wherein the object node corresponds to the target object.

4. The method of claim 3, wherein the history information of the one or more other objects comprises any one or any combination of any two or more of:
a previous state of the one or more other objects, comprising any one or any combination of any two or more of a previous position coordinate of the one or more other objects, a previous direction of the one or more other objects, and a positional relationship between the one or more other objects and the target object;
a second instruction previously performed in response to the one or more other objects;
time information corresponding to the second instruction; and
a previous user that issued the second instruction.

5. The method of claim 1, wherein the updating of the dynamic scene graph comprises storing the history information in a plurality of slots of an object node corresponding to the target object in the dynamic scene graph in a form of a stack data structure.

6. The method of claim 1,
wherein the updating of the dynamic scene graph comprises, in response to another robot being located in a space in which the target robot executes the target instruction, updating the dynamic scene graph by adding information on the target robot that executed the target instruction to the history information corresponding to the target object, and
further comprising sharing the updated dynamic scene graph with the other robot.

7. The method of claim 1, further comprising recognizing a voice of a user corresponding to the target instruction,
wherein the updating of the dynamic scene graph comprises updating the dynamic scene graph by adding information on the user whose voice has been recognized to the history information corresponding to the object node in the dynamic scene graph.

8. The method of claim 7, wherein the controlling of the target robot comprises controlling the target robot to execute the target instruction for the user whose voice has been recognized.

9. The method of claim 1, wherein the controlling of the target robot comprises:
supplementing a missing information item that is missing from the target instruction, based on the updated dynamic scene graph; and
controlling the target robot according to the target instruction with the information item supplemented.

10. The method of claim 1, wherein the target instruction comprises either one or both of an instruction in a form of text and an instruction in a form of voice, for a task of the target robot.

11. A device comprising:
one or more processors configured to:
update a dynamic scene graph by adding, to the dynamic scene graph, object-level history information corresponding to a target object, of which a state changes according to an interaction with a robot that occurs through an execution of an instruction for a task of a target robot; and
control the target robot based on the updated dynamic scene graph, in response to receiving a target instruction corresponding to the target object.

12. The device of claim 11, wherein the history information comprises any one or any combination of any two or more of:
a previous state of the target object, comprising any one or any combination of any two or more of a previous position coordinate of the target object, a previous direction of the target object, or a positional relationship with one or more other objects located in a same space as the target object;
a first instruction previously performed in response to the target object;
time information corresponding to the first instruction; and
a previous user that issued the first instruction.

13. The device of claim 11, wherein the one or more processors are configured to update the dynamic scene graph by adding, to an object node, history information of one or more other objects, of which a state changes together with the target object due to the interaction, in a form of an attribute, wherein the object node corresponds to the target object.

14. The device of claim 13, wherein the history information of the one or more other objects comprises any one or any combination of any two or more of:
a previous state of the one or more other objects, comprising at least one of a previous position coordinate of the one or more other objects, a previous direction of the one or more other objects, or a positional relationship between the one or more other objects and the target object;
a second instruction previously performed in response to the one or more other objects;
time information corresponding to the second instruction; and
a previous user that issued the second instruction.

15. The device of claim 11, wherein the one or more processors are configured to store the history information in a plurality of slots of an object node corresponding to the target object in the dynamic scene graph in a form of a stack data structure.

16. The device of claim 11, wherein the one or more processors are configured to:
in response to another robot being located in a space in which the target robot executes the target instruction, update the dynamic scene graph by adding information on the target robot that executed the target instruction to the history information corresponding to the target object; and
share the updated dynamic scene graph with the other robot.

17. The device of claim 11, wherein the one or more processors are configured to:
recognize a voice of a user corresponding to the target instruction; and
update the dynamic scene graph by adding information on the user whose voice has been recognized to the history information corresponding to the object node in the dynamic scene graph.

18. The device of claim 17, wherein the one or more processors are configured to control the target robot to execute the target instruction for the user whose voice has been recognized.

19. The device of claim 11, wherein the one or more processors are configured to:
supplement a missing information item that is missing from the target instruction, based on the updated dynamic scene graph; and
control the target robot according to the target instruction with the information item supplemented.

20. The device of claim 11, further comprising a communication circuit configured to receive either one or both of an instruction in a form of text and an instruction in a form of voice, for the task of the target robot.
